(19) United States
(12) Patent Application Publication
(10) Pub. No.: US 2021/0089253 A1
(43) Pub. Date: Mar. 25, 2021

(54) IMAGE FORMING APPARATUS, METHOD OF CONTROLLING IMAGE FORMING APPARATUS, AND STORAGE MEDIUM

(71) Applicant: CANON KABUSHIKI KAISHA, Tokyo (JP)

(72) Inventor: Takayuki Kaneko, Machida-shi (JP)

(21) Appl. No.: 17/025,636

(22) Filed: Sep. 18, 2020

(30) Foreign Application Priority Data
Sep. 24, 2019 (JP) 2019-173143

(51) Int. Cl. G06F 3/12; G06F 21/31

(52) U.S. Cl. CPC G06F 3/1238; G06F 3/1222; G06F 21/31

(57) ABSTRACT

An image forming apparatus performs, when a plurality of print jobs stored in association with identification information about an authenticated user include one or more first print jobs requiring a user input operation and one or more second print jobs not requiring a user input operation, control to start to execute the second print job before receiving the user input operation for the first print job in response to designation of an object.

### BACKGROUND OF THE INVENTION

### Field of the Invention

The present disclosure relates to an image forming apparatus, a method of controlling the image forming apparatus, and a storage medium.

### Description of the Related Art

In recent years, an image forming apparatus that stores a print job submitted from a printer driver once in a hard disk in the image forming apparatus, authenticates the stored print job from an operation unit in the image forming apparatus by a user, and executes the stored print job exists for the purpose of improving security.

There has been an image forming apparatus capable of executing a specific function of an image forming apparatus, such as printing and facsimile transmission of a stored print job using a shortcut function. The shortcut function means a function of previously defining a processing content required to execute a specific function to quickly execute the specific function using the defined processing content when executing the specific function.

Japanese Patent Application Laid-Open No. 2015-194941 describes displaying a specific confirmation screen before starting to execute a shortcut function for a scan data processing function and asking a user for confirmation whether processing may be advanced when a specific confirmation processing execution condition is established.

In the image forming apparatus, the above-described shortcut function enables printing for print data stored in the image forming apparatus to be immediately performed. A plurality of print data stored in the image forming apparatus may include print data requiring a user input operation such as a password before printing is performed and print data not requiring a user input operation. In such a case, when a user input operation is received before the execution of the shortcut function is started, as disclosed in Japanese Patent Application Laid-Open No. 2015-194941, described above, start of printing of the print data not requiring a user input operation is delayed. As a result, a time period elapsed until the printing is completed may be lengthened.

### SUMMARY OF THE INVENTION

The present disclosure is directed to an image processing apparatus that is characterized by comprising: one or more memories; and one or more processors that execute a set of instructions to: receive a print job from an information processing apparatus; store the received print job in a storage device in association with identification information about a user; authenticate the user; and execute at least one print job among the print jobs stored in association with the identification information about the authenticated user in response to designation of an object for executing the at least one print job without the user selecting the at least one print job, wherein control is performed to start to execute, when the plurality of print jobs stored in association with the identification information about the authenticated user include one or more first print jobs requiring a user input operation and one or more second print jobs not requiring a user input operation, the second print job before receiving the user input operation for the first print job in response to the designation of the object.

Further features of the present invention will become apparent from the following description of exemplary embodiments with reference to the attached drawings.

### BRIEF DESCRIPTION OF THE DRAWINGS

FIG. 1 is a network configuration diagram of a printing system including an image forming apparatus according to the present embodiment.

FIG. 2 is an internal configuration diagram of the image forming apparatus according to the present embodiment.

FIG. 3 is a functional configuration diagram of system software of the image forming apparatus according to the present embodiment.

FIG. 4 is an internal configuration diagram of a personal computer.

FIG. 5 is a functional configuration diagram of system software of the personal computer.

FIG. 6 is a flowchart for describing processing for submitting a print job.

FIG. 7 is a diagram illustrating the print job generated by a printer driver.

FIG. 8 is a flowchart for describing processing for storing the print job.

FIG. 9 is a diagram illustrating a forced storage mode setting screen.

FIG. 10 is a diagram illustrating a forced storage mode setting value.

FIG. 11 is a diagram illustrating a bibliographic information list.

FIG. 12 is a diagram illustrating a user authentication screen.

FIG. 13 is a diagram illustrating a function selection screen.

FIG. 14 is a diagram illustrating a print job list screen.

FIG. 15 is a flowchart for describing printing processing using a shortcut function.

FIG. 16 is a diagram illustrating a password input screen for secret printing.

FIGS. 17A, 17B and 17C are diagrams respectively illustrating a secret print job list, a normal print job list and a print job.

FIG. 18 is a diagram illustrating post-login automatic print mode setting screen.

FIG. 19 is a diagram illustrating a post-login automatic print mode setting value.

FIG. 20 is a flowchart for describing post-login automatic printing processing.

### DESCRIPTION OF THE EMBODIMENTS

Preferred embodiments of the present invention will now be described in detail in accordance with the accompanying drawings.

### First Embodiment

In the present embodiment, a configuration in which a required time period elapsed until printing is completed when a plurality of print jobs including a print job requiring a user input are printed using a shortcut function is shortened will be described.

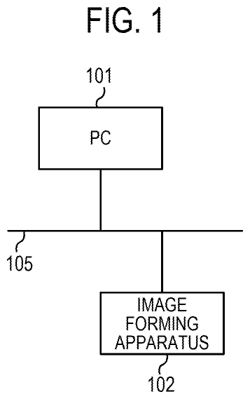

FIG. 1 is a diagram illustrating an example of a network configuration of a printing system including an image forming apparatus according an embodiment of the present disclosure.

As illustrated in FIG. 1, a personal computer (PC) 101 that submits a print job and an image forming apparatus 102 that processes the submitted print job are connected to a network (LAN) 105. Examples of the image forming apparatus 102 include an MFP (multifunction peripheral) and a printer. The respective numbers of PCs and image forming apparatuses to be connected to the network (LAN) 105 are not limited to these.

The image forming apparatus 102 manages bibliographic information for uniquely specifying the print job submitted from the PC 101. Although a submission source of the print job is the PC 101 in the present embodiment, the submission source may be devices (e.g., a portable terminal and another image forming apparatus) other than the PC.

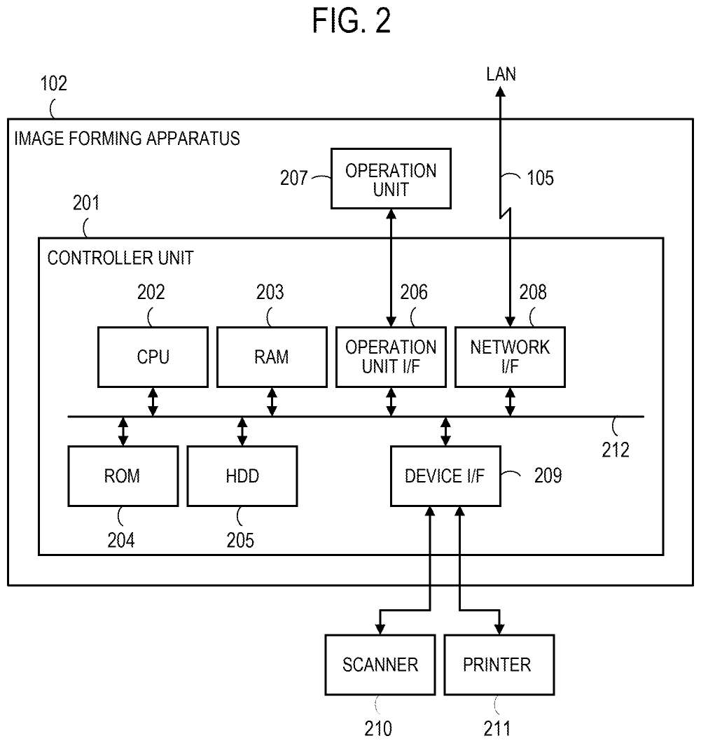

FIG. 2 is a block diagram illustrating an example of an internal configuration of the image forming apparatus 102.

In a controller unit 201 in the image forming apparatus 102, a CPU 202 is a calculation device that controls the entire system. A RAM 203 is a system work memory for the CPU 202 to operate and an image memory for temporarily storing image data. In the RAM 203, programs such as an operating system (OS), system software and application software and data are also arranged.

A ROM 204 stores a system boot program.

A hard disk drive (HDD) 205 stores an OS, system software, application software, image data, setting data and the like. Another storage device such as a solid state drive (SSD) may be provided instead of or together with the HDD 205. The CPU 202 implements various types of control by loading the programs to be stored in the ROM 204, the HDD 205 and the like into the RAM 203 and executing the loaded programs, as needed.

An operation unit I/F 206 is an interface unit with an operation unit 207, and outputs information to be displayed on the operation unit 207 to the operation unit 207. The operation unit I/F 206 receives information input by a user from the operation unit 207.

A network I/F 208 connects with the LAN 105, to input and output information to and from a PC or another image forming apparatus connected onto the same LAN.

A device I/F 209 inputs and outputs image data by connecting a scanner 210 and a printer 211 as an image input/output device to the controller unit 201.

The above-described devices are arranged on a system bus 212.

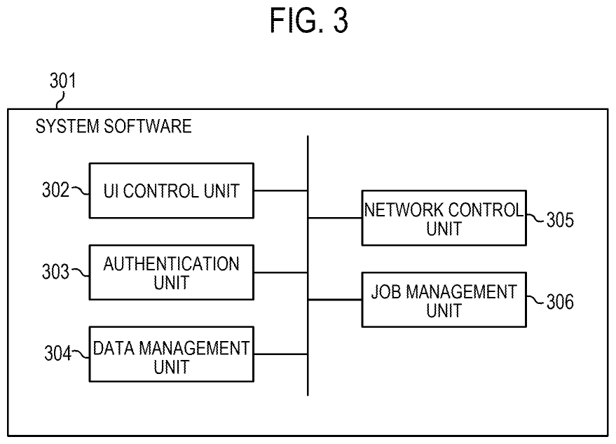

FIG. 3 is a block diagram illustrating an example of a functional configuration of system software of the image forming apparatus 102.

System software 301 is stored in a storage device as any one of the RAM 203, the ROM 204 and the HDD 205, and is implemented to function by being executed by the CPU 202.

A UI control unit 302 receives via the operation unit I/F 206 information input using the operation unit 207 by the user, and transmits the information to an authentication unit 303, a data management unit 304 and a job management unit 306. The UI control unit 302 receives a response from each of the authentication unit 303, the data management unit 304 and the job management unit 306, and outputs information about the response to the operation unit 207 via the operation unit I/F 206.

The authentication unit 303 performs user authentication processing based on authentication information received from the UI control unit 302, and returns a result of the user authentication processing to the UI control unit 302.

The data management unit 304 receives respective requests to write and read data from the UI control unit 302, a network control unit 305 and the job management unit 306, to write and read data stored in the HDD 205. The data management unit 304 returns respective results of the writing and reading of the data to the UI control unit 302, the network control unit 305 and the job management unit 306.

The network control unit 305 receives a request from an information processing apparatus such as the PC 101 or any image forming apparatus connected onto the LAN 105 via the network I/F 208. The network control unit 305 requests the data management unit 304 and the job management unit 306 to perform processing in response to the received request. Alternatively, the network control unit 305 receives a response from each of the data management unit 304 and the job management unit 306. The network control unit 305 transmits the received response to the information processing apparatus such as the PC 101 or any image forming apparatus connected onto the LAN 105 via the network I/F 208.

The job management unit 306 receives a job execution request from each of the UI control unit 302 and the network control unit 305, to manage a job. The job management unit 306 transmits a request to write and read data to the data management unit 304. The job management unit 306 receives a response from the data management unit 304, and transmits a state of the job to the UI control unit 302 and the network control unit 305. The job management unit 306 receives a job execution request from the UI control unit 302, and controls respective operations of the scanner 210 and the printer 211 via the device I/F 209. The job management unit 306 receives respective operation states of the scanner 210 and the printer 211 via the device I/F 209, and transmits the operation states to the UI control unit 302.

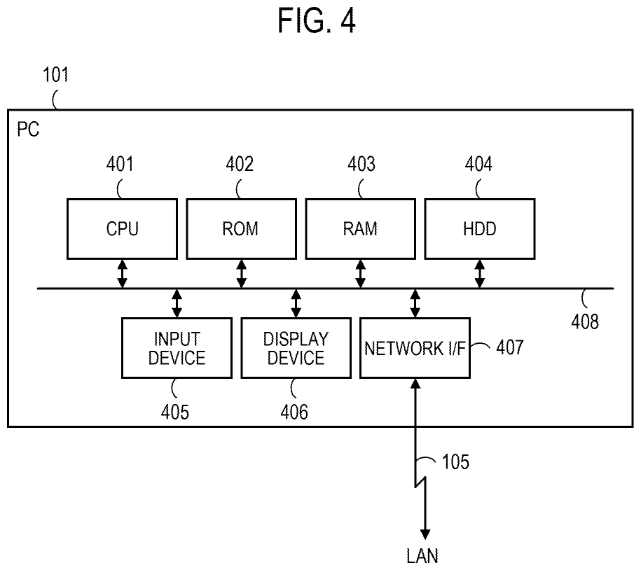

FIG. 4 is a block diagram illustrating an example of an internal configuration of the PC 101.

In the PC 101, a CPU 401 is a calculation device that controls the entire system. A ROM 402 stores a program and data related to each processing. A RAM 403 is a system work memory for the CPU to operate and is a storage memory storing temporary data related to each processing.

A hard disk drive (HDD) 404 stores a program and data related to each processing, temporary data, application data and the like. Another storage device such as a solid state drive (SSD) may be provided instead of or together with the HDD 404. The CPU 401 implements various types of control by loading programs to be stored in the ROM 402, the HDD 404 and the like into the RAM 403 and executing the loaded programs, as needed.

Examples of an input device 405 include a keyboard, a pointing device and a touch panel that receive an instruction input to the device. A display device 406 displays an operating condition of the device and information to be output by each of the programs operating on the device.

A network I/F 407 connects with the network (LAN) 105, to input and output information to and from another PC or image forming apparatus connected onto the same LAN.

The above-described elements are arranged on a system bus 408.

The CPU 401 performs processing based on programs respectively corresponding to an operating system (OS), a printer driver and an application stored in the HDD 404 so that a function (or processing) by each of the OS and the printer driver is implemented.

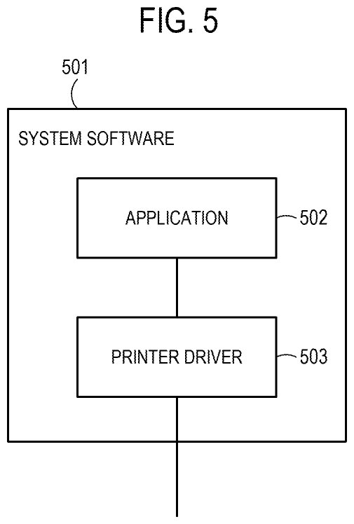

FIG. 5 is a block diagram illustrating a configuration of system software of the PC 101.

System software 501 is stored in a storage device as any one of the ROM 402, the RAM 403 and the HDD 404, and is implemented to function by being executed by the CPU 401.

The system software 501 includes an application 502 and a printer driver 503.

The application 502 is a tool that generates and edits an image or a document using the input device 405 such as a pointing device or a keyboard while seeing the display device 406 in the PC 101, for example.

The printer driver 503 is software for converting the image or the document generated by the application 502 into a format interpretable by the image forming apparatus 102.

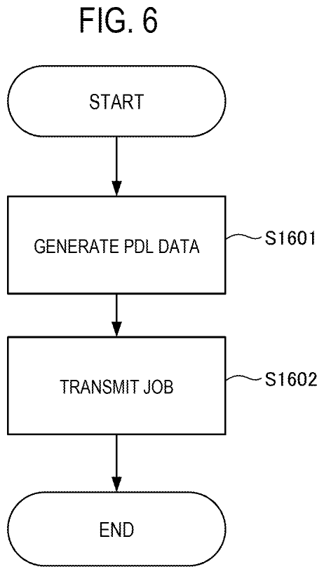

FIG. 6 is a flowchart for describing processing for transmitting a print job to be executed by the application 502 to the image forming apparatus 102 (print job submission processing). That is, the processing in the flowchart is performed by the CPU 401 in the PC 101.

The printer driver 503 generates PDL data according to data such as an image, a document attribute such as a document name, and print setting information set in the printer driver (S1601).

Further, the printer driver 503 transmits a print job including the PDL data generated in S1601 described above to the image forming apparatus 102 (S1602).

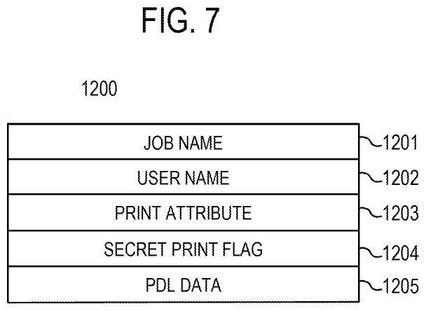

FIG. 7 is a diagram illustrating an example of the print job generated by the printer driver.

As illustrated in FIG. 7, a print job 1200 includes a job name 1201, a user name 1202, a print attribute 1203, a secret print flag 1204 and PDL data 1205.

The job name 1201 represents a name of the print job.

The user name 1202 is a name (identification information) for identifying a user who has generated the print job.

The print attribute 1203 is a print setting representing print information such as single-sided/double-sided, a number of print copies, and a color mode.

The secret print flag 1204 is a flag indicating whether the print job is processed as secret printing.

The PDL data 1205 is print data including a bit map, rectangular data and the like and for generating image data at the time of printing.

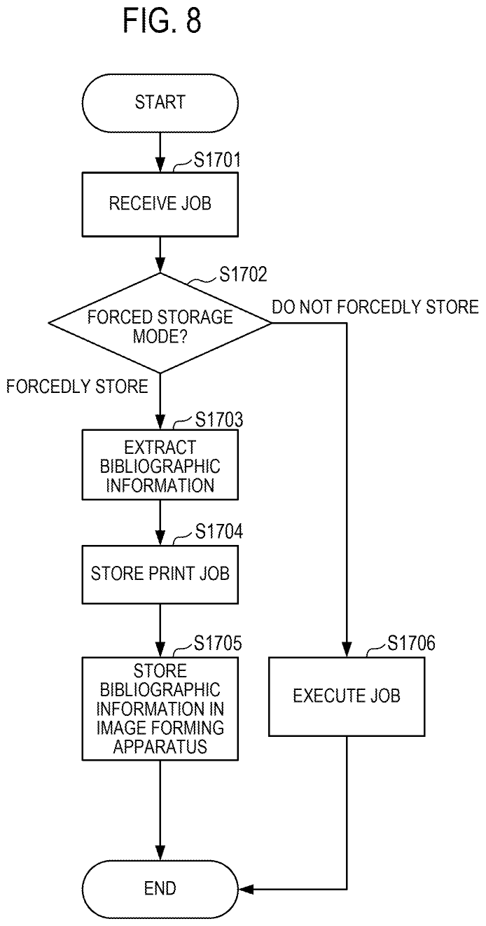

FIG. 8 is a flowchart for describing processing for storing a print job in the system software 301. That is, processing in the flowchart is performed by the CPU 202 in the image forming apparatus 102. In the present embodiment, the print job is submitted to the image forming apparatus 102 from the PC 101.

The network control unit 305 transmits the print job submitted from the PC 101 to the job management unit 306 upon receiving the print job (S1701).

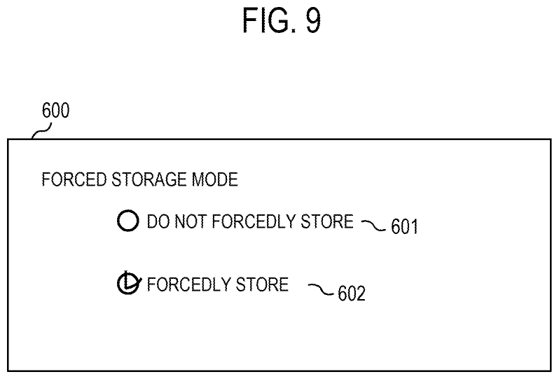

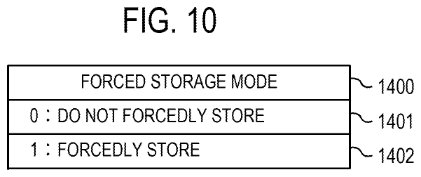

The job management unit 306 confirms a forced storage mode 1400 upon receiving the print job (S1702). The forced storage mode will be described with reference to FIGS. 9 and 10.

FIG. 9 is a diagram illustrating an example of a setting screen of the forced storage mode in the system software 301. That is, the screen is displayed on a display section of the operation unit 207 by processing of the CPU 202 in response to a predetermined operation from the operation unit 207 in the image forming apparatus 102.

On a forced storage setting screen 600, “do not forcedly store” 601 or “forcedly store” 602 can be set as the forced storage mode 1400.

A setting value set on the forced storage setting screen 600 is stored in the HDD 205, the RAM 203 and the like by the network control unit 305 as the forced storage mode 1400 illustrated in FIG. 10. The system software 301 can refer to the forced storage mode 1400 at any timing.

FIG. 10 is a diagram illustrating an example of a forced storage mode setting value in the image forming apparatus 102.

In the present embodiment, “0: do not forcedly store” 1401 or “1: forcedly store” 1402 is selectively settable as the forced storage mode setting value.

Although it is assumed that an administrator user of the image forming apparatus 102 sets a forced storage mode in the present embodiment, users may be able to respectively designate forced storage modes.

Note refer again to the flowchart of FIG. 8.

If “0: do not forcedly store” 1401 is set as the forced storage mode 1400 in S1702 (“do not forcedly store” in S1702), the job management unit 306 advances the processing to S1706.

In S1706, the job management unit 306 executes the print job using the printer 211, and ends the processing in the flowchart.

On the other hand, if “1: forcedly store” 1402 is set as the forced storage mode 1400 in S1702 described above (“forcedly store” in S1702), the job management unit 306 transmits the print job to the data management unit 304, and advances the processing to S1703.

In S1703, the data management unit 304 analyzes the print job received from the job management unit 306, and extracts bibliographic information.

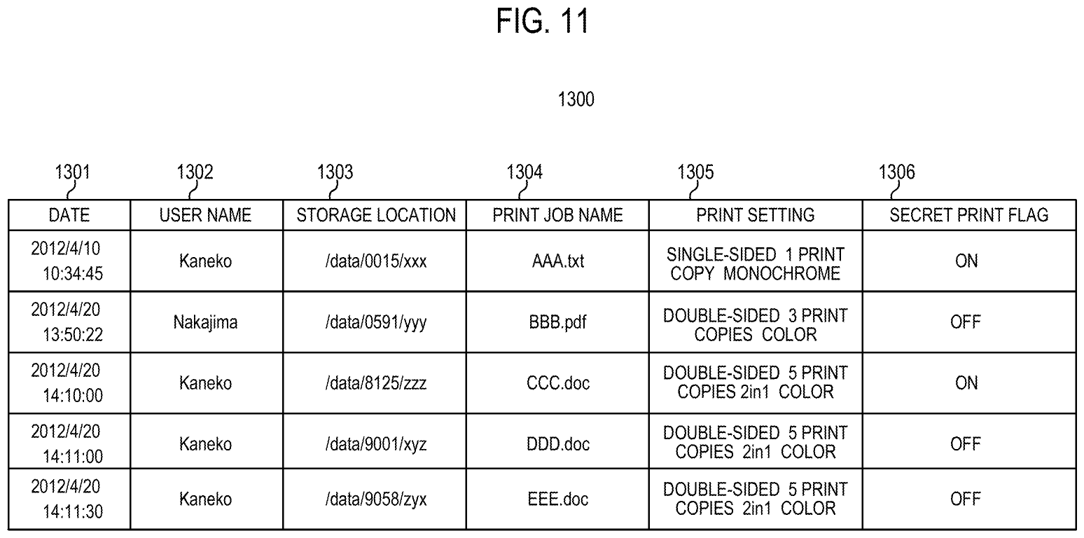

Then, the data management unit 304 stores the received print job and the extracted bibliographic information (e.g., information as illustrated in FIG. 11) in the HDD 205 (S1704 and S1705), and the processing in the flowchart ends. In S1705, the data management unit 304 may transmit the extracted bibliographic information to an external system such as a cloud server that manages the bibliographic information.

FIG. 11 is a diagram illustrating an example of a bibliographic information list.

In the present embodiment, a bibliographic information list 1300 includes a date 1301 on which a print job has been submitted, a user name 1302 of a user who has submitted the print job, a storage location 1303 of the submitted print job, a print job name 1304, a print setting 1305 and a secret print flag 1306.

As described above, the print job is stored. That is, the image forming apparatus 102 stores the print job received from the information processing apparatus such as the PC 101 in the storage device (the HDD 205) in association with user identification information (here, a user name).

Then, a method of printing a print job stored as described above will be described.

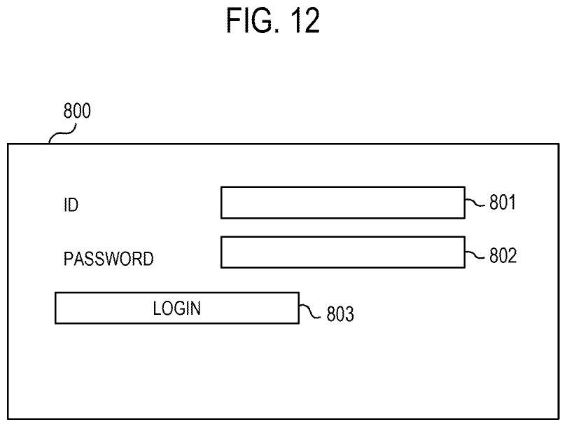

FIG. 12 is a diagram illustrating an example of a user authentication screen in the system software 301. That is, the screen is displayed on the display section of the operation unit 207 by processing of the CPU 202 in the image forming apparatus 102.

The user respectively inputs an ID and a password to an ID 801 and a PASSWORD 802 on a user authentication screen 800, and presses a log-in button 803, to request the authentication unit 303 to perform user authentication.

The authentication unit 303 performs the user authentication based on information input on the user authentication screen 800, and performs any processing depending on a result of the user authentication. User authentication processing itself may use a known authentication method, and hence detailed description thereof is omitted.

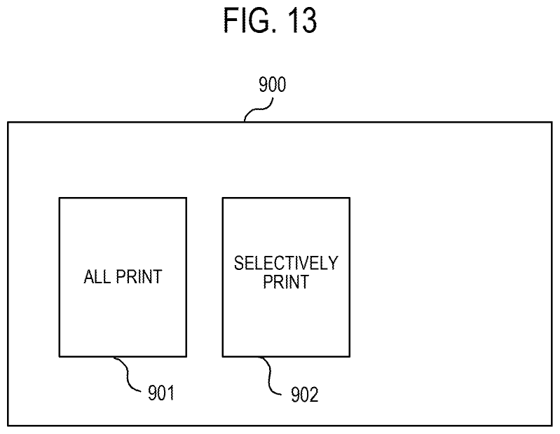

When the authentication has been successfully performed, a function selection screen 900 as illustrated in FIG. 13 is displayed on the operation unit 207.

FIG. 13 is a diagram illustrating an example of the function selection screen 900 for selecting a function of the image forming apparatus to be displayed on the operation unit 207 by the UI control unit 302 when the user has logged in to the image forming apparatus 102.

In the present embodiment, the function selection screen 900 includes an “all print” button 901 and a “selectively print” button 902.

The “all print” button 901 is a shortcut button for printing all print jobs stored by a login user himself/herself using work to only press the button (issuing an instruction to perform printing).

The “selectively print” button 902 is a shortcut button for displaying a print job list screen 1000 on the operation unit 207 by the login user.

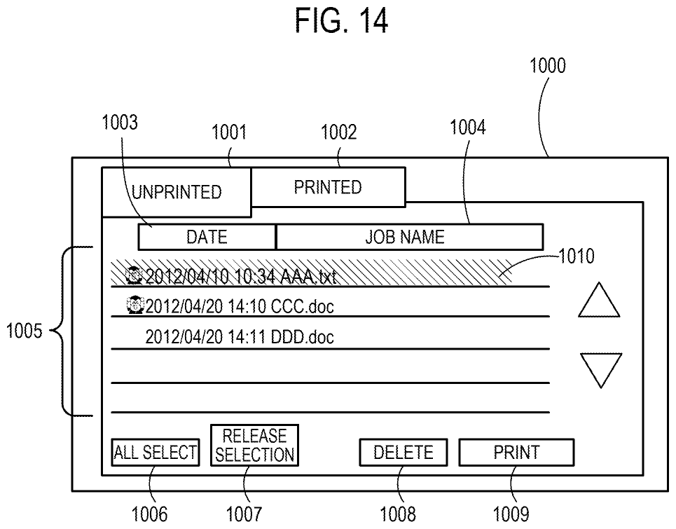

FIG. 14 is a diagram illustrating an example of the print job list screen 1000 to be displayed on the operation unit 207 by the UI control unit 302 when the user presses the “selectively print” button 902 on the function selection screen 900.

Information to be displayed on the print job list screen 1000 is based on a print job corresponding to a user who has logged in and bibliographic information corresponding to the print job, which are acquired from inside the HDD 205 by the data management unit 304.

On the print job list screen 1000, an unprinted button 1001 is a button for displaying a print job, which has not yet been printed, on a job list display area 1005.

A printed button 1002 is a button for displaying a print job, which has already been printed in the past, on the job list display area 1005.

The example illustrated in FIG. 14 corresponds to a display example of the print job list screen 1000 with the unprinted button 1001 pressed.

On the job list display area 1005, a date 1003 is an area where a date on which the print job has been stored is displayed. A job name 1004 is an area where a job name of the print job is displayed.

On the job list display area 1005, the user can select any print job. A screening display 1010 indicates that the print job remains selected by the user. When the user presses an all selection button 1006, all print jobs displayed on the print job list display area 1005 are each brought into a selected state. When the user presses a selection release button 1007, the selected state of the selected print job is released.

When the user presses a deletion button 1008 with the print job selected on the job list display area 1005, the selected print job and bibliographic information corresponding to the print job are deleted from inside the HDD 205 by the data management unit 304.

When the user presses a print button 1009 (issues an instruction to perform printing) with the print job selected on the job list display area 1005, the job management unit 306 executes the selected print job using the printer 211.

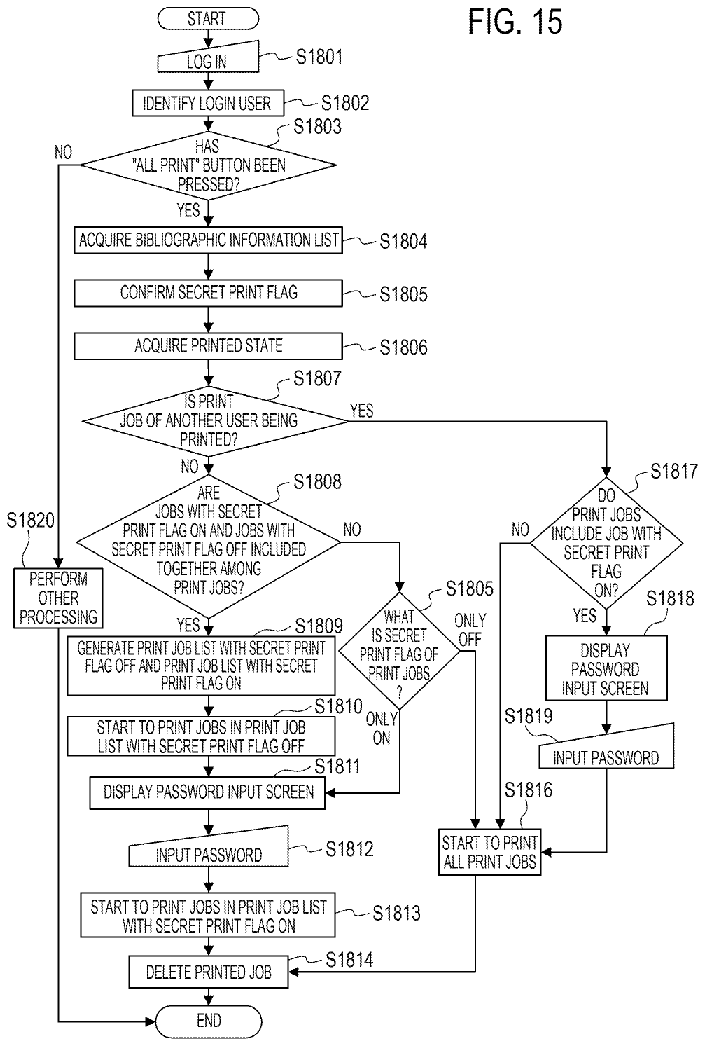

FIG. 15 is a flowchart for describing processing for printing print jobs to be executed by the system software 301 when the user presses the “all print” button 901 on the function selection screen 900, that is, a flowchart for describing printing processing using a shortcut function.

The authentication unit 303 performs authentication processing in response to an authentication request to the image forming apparatus 102 from the user authentication screen 800 (FIG. 12) by the user and brings the user into a logged-in state (S1801) when authentication has been successfully performed, and advances the processing to S1802.

In S1802, the job management unit 306 acquires an identifier of the login user by the authentication unit 303.

Then, when the job management unit 306 detects that the “all print” button 901 has been pressed (Yes in S1803), the job management unit 306 advances the processing to S1804.

In S1804, the job management unit 306 acquires the bibliographic information list 1300.

Then, the job management unit 306 confirms the secret print flag 1306 of each of the print jobs stored by the login user included in the acquired bibliographic information list 1300 (S1805).

Then, the job management unit 306 confirms a printing state of the printer 211 (S1806).

Then, the job management unit 306 determines whether the printer 211 is printing a print job of another user (S1807). If the job management unit 306 determines that the printer 211 is not printing the print job of the other user (No in S1807), the job management unit 306 advances the processing to S1808.

In S1808, the job management unit 306 determines whether the print jobs each with the secret print flag on and the print jobs each with the secret print flag off are included together among the print jobs stored by the login user. If the job management unit 306 determines that the print jobs are included together (Yes in S1808), the job management unit 306 advances the processing to S1809.

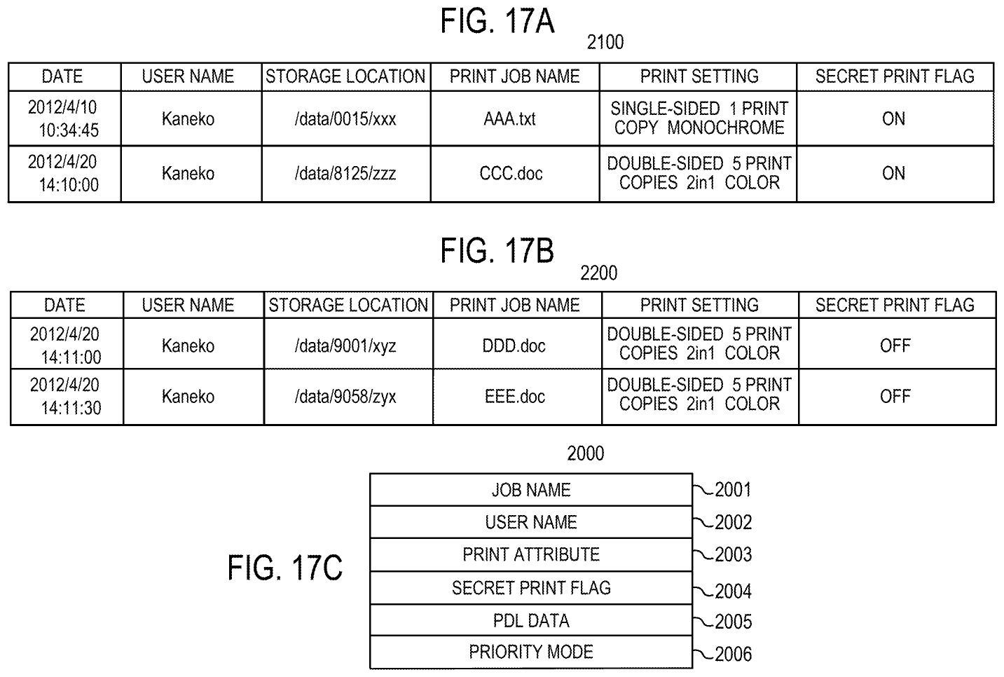

In S1809, the job management unit 306 generates a secret print job list 2100 and a normal print job list 2200 from the bibliographic information list 1300. The secret print job list 2100 and the normal print job list 2200 will be described with reference to FIGS. 17A to 17C.

FIG. 17A is a diagram illustrating an example of the secret print job list 2100.

FIG. 17B is a diagram illustrating an example of the normal print job list 2200.

The secret print job list 2100 illustrated in FIG. 17A is, among print jobs managed by the bibliographic information list 1300, a list of the print jobs stored by the login user and each with the secret print flag on.

The normal print job list 2200 illustrated in FIG. 17B is, among the print jobs managed by the bibliographic information list 1300, a list of the print jobs stored by the login user and each with the secret print flag off.

Note refer again to the flowchart of FIG. 15.

When the secret print job list 2100 and the normal print job list 2200 described above are generated, the job management unit 306 starts to print the print jobs managed by the normal print job list 2200 (S1810).

Then, the job management unit 306 displays a password input screen 1100 into which a password is to be input to print the print jobs each with the secret print flag on on the operation unit 207 using the UI control unit 302 (S1811).

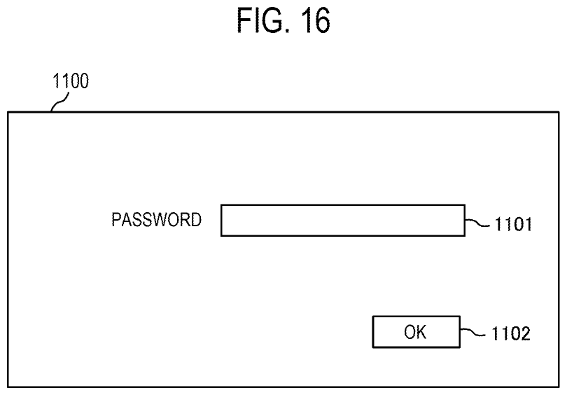

FIG. 16 is a diagram illustrating an example of the password input screen 1100 for secret printing.

The job management unit 306 detects that the user has input a password into an input column 1101 of the password input screen 1100 and has pressed an OK button 1102, determines that the input password is correct (S1812), and advances the processing to S1813.

In S1813, the job management unit 306 starts to print the print jobs managed by the secret print job list 2100.

Then, the job management unit 306 deletes the printed print job from the HDD 205 using the data management unit 304 (S1814), and the processing in the flowchart ends.

If the job management unit 306 determines that the print jobs each with the secret print flag on and the print jobs each with the secret print flag off are not included together among the print jobs stored by the login user in S1808 described above (No in S1808), the job management unit 306 advances the processing to S1815.

In S1815, the job management unit 306 determines whether the print jobs stored by the login user include only the print jobs each with the secret print flag on. If the job management unit 306 determines that the print jobs include only the print jobs each with the secret print flag on (“only ON” in S1815), the job management unit 306 advances the processing to S1811.

On the other hand, if the job management unit 306 determines that the print jobs stored by the login user include only the print jobs each with the secret print flag off in S1815 described above (“only OFF” in S1815), the job management unit 306 advances the processing to S1816.

In S1816, the job management unit 306 starts to print all the print jobs stored by the login user, and advances the processing to S1814.

If the job management unit 306 determines that the printer 211 is printing the print job of the other user in S1807 described above (Yes in S1807), the job management unit 306 advances the processing to S1817.

In S1817, the job management unit 306 determines whether the print jobs stored by the login user include the print jobs each with the secret print flag on. If the job management unit 306 determines that the print jobs do not include the print jobs each with the secret print flag on (No in S1817), the job management unit 306 advances the processing to S1816. In S1816, the job management unit 306 starts to print all the print jobs stored by the login user.

On the other hand, if the job management unit 306 determines that the print jobs stored by the login user include the print jobs each with the secret print flag on in S1817 described above (Yes in S1817), the job management unit 306 advances the processing to S1818.

In S1818, the job management unit 306 displays the above-described password input screen 1100.

Then, the job management unit 306 detects that the user has input the password into the password input screen 1100 and has pressed the OK button 1102 and determines that the input password is correct (S1819), and advances the processing to S1816. In S1816, the job management unit 306 starts to print all the print jobs stored by the login user.

If the passwords respectively input in S1812 and S1819 described above are not correct, retry processing such as re-input of the password is required. However, detailed description of the retry processing is omitted in the present embodiment.

If the job management unit 306 does not detect that the “all print” button 901 has been pressed in S1803 described above (No in S1803), the job management unit 306 advances the processing to S1820.

In S1820, the system software 301 performs other processing, and the processing in the flowchart ends. Although examples of the other processing in S1820 can include redrawing of the operation unit 207, detail description thereof is omitted.

In the present embodiment, a configuration in which printing is performed, starting with the print job not requiring a user input when the “all print” button 901 has been pressed (Yes in S1803) has been described. However, even when the “selectively print” button 902 has been pressed and the print button 1009 has been pressed by selecting the print job on the print job list screen 1000, similar control may be performed with the selected one or more print jobs respectively used as targets. That is, before receiving, for the print job requiring a user input operation among the selected one or more print jobs, the user input operation, processing for printing the print job not requiring a user input operation may be started. As a result, a required time period elapsed until printing for all the selected print jobs is completed can be shortened by preventing, among the selected print jobs, start of printing of the print job not requiring a user input operation from being delayed.

As described above, in the first embodiment, when the plurality of print jobs including the print job requiring a user input are printed using a shortcut function, printing is performed, starting with the print job not requiring a user input. As a result, even when a shortcut function of the “all print” button 901 or the like has been selected, a required time period elapsed until printing is completed can be shortened. When the user performs printing using a shortcut function, if the other user has been performing printing, the printing is started after the user input so that printing can be prevented from being performed in a printing order not intended by the user.

In the present embodiment, when the other user is performing printing in S1806 and S1807 described above, processing that affects the printing order (S1809 to S1813) is not performed, to start the printing. However, printing may be started without performing the processing that affects the printing order (S1809 to S1813) when an instruction “printing order priority” has been issued to the print job as another configuration. In this case, the print job has a structure, as illustrated in FIG. 17C.

FIG. 17C is a diagram illustrating an example of a print job 2000 in another form of the first embodiment. The print job 2000 includes a job name 2001, a user name 2002, a print attribute 2003, a secret print flag 2004, PDL data 2005 and a priority mode 2006.

The system software 501 enables “speed priority” or “printing order priority” to be selectively designated in the priority mode 2006, and the job management unit 306 may start printing without performing processing that affects the printing order when there is only one job in which “printing order priority” is designated. In this case, the job management unit 306 starts printing processing in the order of the date 1301, for example.

### Second Embodiment

In a second embodiment, a configuration in which a required time period elapsed until printing is completed when a plurality of print jobs including a print job requiring a user input are printed using a post-login automatic printing function is shortened will be described. The post-login automatic printing function means a function of a job management unit 306 automatically printing print jobs stored by a login user when user authentication has been successfully performed by a user authentication screen 800. In the present embodiment, a network configuration, an internal configuration and a software configuration of an image forming apparatus 102, an internal configuration and a software configuration of a PC 101 are the same as those in the above-described first embodiment, and hence detailed description thereof is omitted.

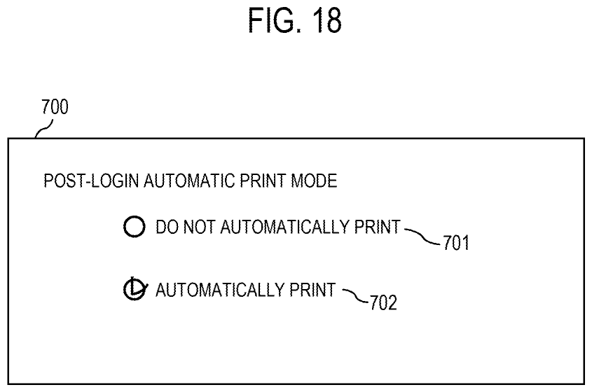

FIG. 18 is a diagram illustrating an example of a setting screen of a post-login automatic print mode in a system software 301. That is, the screen is displayed on a display section of an operation unit 207 in the image forming apparatus 102 by processing of a CPU 202 in response to a predetermined operation from the operation unit 207.

In the present embodiment, a user makes either one of “do not automatically print” 701 and “automatically print” 702 selectively settable on a post-login automatic print mode setting screen 700.

If “do not automatically print” 701 has been selected, the print job of the user is not automatically printed when the user has performed user authentication for the image forming apparatus 102.

If “automatically print” 702 has been selected, the print job of the user is printed when the user has performed user authentication for the image forming apparatus 102. Details will be described below.

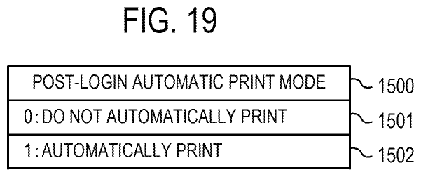

A post-login automatic print mode setting value designated on the post-login automatic print mode setting screen 700 by the user is managed in a post-login automatic print mode 1500 illustrated in FIG. 19, and is held in a RAM 203 and an HDD 205. The job management unit 306 can refer to the post-login automatic print mode 1500 set at any timing.

FIG. 19 is a diagram illustrating an example of the post-login automatic print mode setting value in the image forming apparatus 102. Although it is assumed that an administrator user of the image forming apparatus 102 sets the post-login automatic print mode in the present embodiment, users may be able to respectively designate post-login automatic print modes.

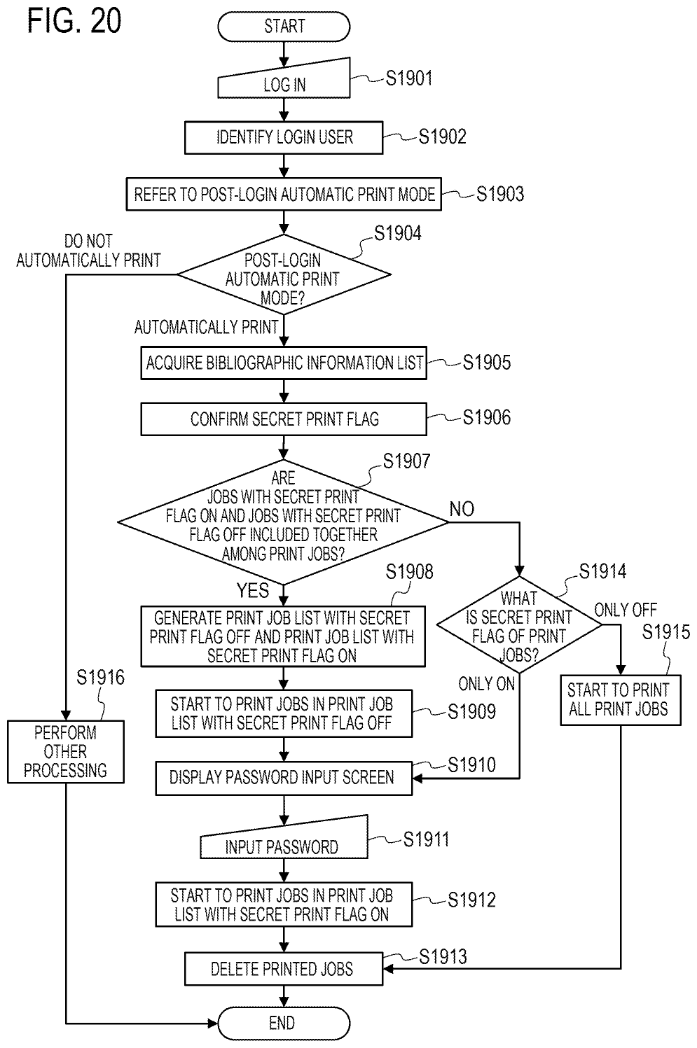

FIG. 20 is a flowchart for describing processing for the job management unit 306 to automatically print print jobs stored by the login user when user authentication has been successfully performed by a user authentication screen 800, that is, a flowchart for describing post-login automatic printing processing.

An authentication unit 303 performs authentication processing in response to an authentication request to the image forming apparatus 102 from the user authentication screen 800 (FIG. 12) by the user and brings the user into a logged-in state (S1901) when authentication has been successfully performed, and advances the processing to S1902.

In S1902, the job management unit 306 acquires an identifier of the login user by the authentication unit 303.

Then, the job management unit 306 refers to the post-login automatic print mode 1500 (S1903).

Then, the job management unit 306 confirms the post-login automatic print mode 1500 referred to in S1903 described above. If the job management unit 306 confirms that the post-login automatic print mode 1500 is “automatically print” (“automatically print” in S1904), the job management unit 306 advances the processing to S1905.

In S1905, the job management unit 306 acquires a bibliographic information list 1300.

Then, the job management unit 306 confirms a secret print flag 1306 of each of the print jobs stored by the login user included in the acquired bibliographic information list 1300 (S1906).

In S1907, the job management unit 306 determines whether the print jobs each with the secret print flag on and the print jobs each with the secret print flag off are included together among the print jobs stored by the login user. If the job management unit 306 determines that the print jobs are included together (Yes in S1907), the job management unit 306 advances the processing to S1908.

In S1908, the job management unit 306 generates a secret print job list 2100 as illustrated in FIG. 17A and a normal print job list 2200 as illustrated in FIG. 17B from the bibliographic information list 1300.

When the secret print job list 2100 and the normal print job list 2200 are generated, the job management unit 306 starts to print the print jobs managed by the normal print job list 2200 (S1909).

Then, the job management unit 306 displays a password input screen 1100 into which a password is to be input to print the print jobs each with the secret print flag on on the operation unit 207 using a UI control unit 302 (S1910).

The job management unit 306 detects that the user has input a password into an input column 1101 of the password input screen 1100 and has pressed an OK button 1102, determines that the input password is correct (S1911), and advances the processing to S1912.

In S1912, the job management unit 306 starts to print the print jobs managed by the secret print job list 2100.

Then, the job management unit 306 deletes the printed print job from the HDD 205 using a data management unit 304 (S1913), and the processing in the flowchart ends.

If the job management unit 306 determines that the print jobs each with the secret print flag on and the print jobs each with the secret print flag off are not included together among the print jobs stored by the login user in S1907 described above (No in S1907), the job management unit 306 advances the processing to S1914.

In S1914, the job management unit 306 determines whether the print jobs stored by the login user include only the print jobs each with the secret print flag on. If the job management unit 306 determines that the print jobs include only the print jobs each with the secret print flag on (“only ON” in S1914), the job management unit 306 advances the processing to S1910.

On the other hand, if the job management unit 306 determines that the print jobs stored by the login user include only the print jobs each with the secret print flag off in S1914 described above (“only OFF” in S1914), the job management unit 306 advances the processing to S1915.

In S1915, the job management unit 306 starts to print all the print jobs stored by the login user, and advances the processing to S1913.

If the job management unit 306 confirms that the post-login automatic print mode 1500 referred to in S1903 is “do not automatically print” in S1904 described above (“do not automatically print” in S1904), the job management unit 306 advances the processing to S1916.

In S1916, the system software 301 performs other processing, and the processing in the flowchart ends. Although examples of the other processing in S1916 can include redrawing of the operation unit 207, detail description thereof is omitted.

If the password input in S1911, described above, is not correct, retry processing such as re-input of the password is required. However, detailed description of the retry processing is omitted in the present embodiment.

As described above, in the second embodiment, the post-login automatic print mode for printing all the print jobs stored by the user authenticated when the user has been authenticated is made settable. Further, printing is performed, starting with the print job not requiring a user input when the plurality of print jobs including the print job requiring a user input are printed using the post-login automatic printing function. Such configurations enable a required time period elapsed until printing is completed in the post-login automatic print mode to be shortened.

As described above, in each of the embodiments, if the submitted print job is stored once in the image forming apparatus and is printed after the user is authenticated from the operation unit in the image forming apparatus, printing is performed, starting with the print job not requiring a user input. While print data not requiring a user input operation is being printed, a user input operation of print data requiring a user input operation is received. As a result, a required time period elapsed until printing is completed can also be shortened by preventing start of printing of the print data not requiring a user input operation from being delayed even when printing processing for a plurality of print data stored in the image forming apparatus is performed.

### Other Embodiments

Respective configurations and contents of various types of data, described above, are not limited to these, but it goes without saying that each of the data has various configurations and contents depending on the application and the purpose.

Although the embodiments have been described above, the present disclosure can take an embodiment as any one of a system, an apparatus, a method, a program, and a storage medium, for example. More specifically, the present disclosure may be applied to a system including a plurality of devices, or may be applied to an apparatus including one device.

A configuration in which all the above-described embodiments are combined is included in the present disclosure.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-173143, filed Sep. 24, 2019, which is hereby incorporated by reference herein in its entirety.

What is claimed is:

1. An image processing apparatus comprising:
one or more memories; and
one or more processors that execute a set of instructions to:
receive a print job from an information processing apparatus;
store the received print job in a storage device in association with identification information about a user;
authenticate the user; and
execute at least one print job among the print jobs stored in association with the identification information about the authenticated user in response to designation of an object for executing the at least one print job without the user selecting the at least one print job,
wherein control is performed to start to execute, when the plurality of print jobs stored in association with the identification information about the authenticated user include one or more first print jobs requiring a user input operation and one or more second print jobs not requiring a user input operation, the second print job before receiving the user input operation for the first print job in response to the designation of the object.

2. The image forming apparatus according to claim 1, wherein the one or more processors further execute the set of instructions to start to execute the second print job, and then display a screen for receiving the user input operation for the first print job.

3. The image forming apparatus according to claim 1, wherein the user input operation includes a password input operation.

4. The image forming apparatus according to claim 1, wherein, in the case where the object is designated, the control is not performed when a print job stored in association with identification information about a user other than the authenticated user is being executed.

5. A control method for an image forming apparatus, the control method comprising:
receiving a print job from an information processing apparatus;
storing the received print job in a storage device in association with identification information about a user;
authenticating the user; and
executing at least one print job among the print jobs stored in association with the identification information about the authenticated user in response to designation of an object for executing the at least one print job without the user selecting the at least one print job,
wherein the control method further comprises performing control to start to execute, when the plurality of print jobs stored in association with the identification information about the authenticated user include one or more first print jobs requiring a user input operation and one or more second print jobs not requiring a user input operation, the second print job before receiving the user input operation for the first print job in response to the designation of the object.

6. A non-transitory computer-readable storage medium on which is stored a computer program for making a computer execute a control method for an image forming apparatus, the control method comprising:
receiving a print job from an information processing apparatus;
storing the received print job in a storage device in association with identification information about a user;
authenticating the user; and
executing at least one print job among the print jobs stored in association with the identification information about the authenticated user in response to designation of an object for executing the at least one print job without the user selecting the at least one print job,
wherein the control method further comprises performing control to start to execute, when the plurality of print jobs stored in association with the identification information about the authenticated user include one or more first print jobs requiring a user input operation and one or more second print jobs not requiring a user input operation, the second print job before receiving the user input operation for the first print job in response to the designation of the object.
